(19) United States
(12) Patent Application Publication
(10) Pub. No.: US 2018/0030894 A1
(43) Pub. Date: Feb. 1, 2018

(54) GAS TURBINE ENGINE COMPRISING AN ADJUSTABLE SPINNER

(71) Applicant: ROLLS-ROYCE PLC, London (GB)

(72) Inventor: Howoong NAMGOONG, Derby (GB)

(73) Assignee: ROLLS-ROYCE PLC, London (GB)

(21) Appl. No.: 15/650,098

(22) Filed: Jul. 14, 2017

(30) Foreign Application Priority Data
Jul. 26, 2016 (GB) 1612888.6

(51) Int. Cl. F02C 7/042; F02K 3/06; F04D 27/00; F02C 7/057

(52) U.S. Cl. CPC F02C 7/042; F02C 7/057; F02K 3/06; F04D 27/002; F04D 29/563

(57) ABSTRACT

A gas turbine engine is disclosed comprising a compressor and an intake leading to the compressor, the compressor having a spinner, at least part of the spinner being adjustable to alter the size of the smallest flow area provided within the intake.

The present disclosure concerns gas turbine engines and methods for their operation. The disclosure may be particularly relevant to higher bypass ratio aero turbofan engines, but is not limited to such applications and may also find application in lower bypass ratio turbofans and turbojets for aero applications and/or turbofans or turbojets for non-aero applications such as industrial power generation.

With increasing rotation speed a compressor can operate with increasing pressure ratio across it. Where however the rotation speed falls too low with respect to the pressure ratio across the compressor it may stall and/or surge (temporary reversal of flow direction). The margin between pressure ratio across a turbine for a given rotation speed and the pressure ratio at which a surge would occur at that rotation speed is called the surge margin.

Maintaining sufficient surge margin under various operation conditions is a known and significant constraint in terms of compressor and whole engine design in the field of gas turbine engines. Furthermore, all else being equal, the trend in civil aviation turbofan engine design to improve efficiency by using ever higher bypass ratio and ever lower fan speed tends to increase fan loading and reduce surge and flutter margin.

Various approaches have been considered for tackling fan stability issues in such circumstances (e.g. variable area nozzle and variable pitch fan) but these require relatively complicated actuation systems and increased weight.

According to a first aspect there is provided a gas turbine engine comprising a compressor and an intake leading to the compressor, the compressor having a spinner, at least part of the spinner being adjustable to alter the size of the smallest flow area provided within the intake. The at least part of the spinner may therefore be used to alter the axial velocity of a main airflow reaching the compressor in use. This in turn offers the possibility of altering the working line of the compressor to increase its surge and flutter margins. Specifically at slower compressor rotation speeds the at least part of the spinner may be used to increase the axial flow velocity, thereby reducing the compressor loading and increasing its stability. Reducing the compressor loading may also reduce a wake created by the compressor and thereby potentially reduce broadband noise created by wake interaction with downstream components (e.g. outlet guide vanes and/or engine section stators). Another potential effect of varying the size of the smallest flow area may be to reduce/prevent choking of the compressor roots. Specifically increasing the size of the smallest flow area may increase diffusion of fluid towards the compressor blade roots. This may be desirable where root choking is more likely, e.g. where the air is of higher density or during take-off.

In some embodiments the gas turbine engine comprises a control system arranged to adjust the at least part of the spinner to alter the smallest flow area provided within the intake. The control system may be arranged to adjust the at least part of the spinner to decrease the smallest flow area where the compressor is rotating slower and increase the smallest flow area where the compressor is rotating faster. A decrease in the smallest flow area may be used to increase the axial velocity of a main airflow reaching the compressor and thereby increase the stall margin where it would otherwise be decreased (e.g. by slower rotation of the compressor). An increase in the smallest flow area may decrease the axial velocity of the main airflow reaching the compressor and thereby increase efficiency where the compressor is at reduced risk of stalling (e.g. where there is faster rotation of the compressor).

In some embodiments the control system comprises an actuator that selectively adjusts the at least part of the spinner to decrease and/or increase the smallest flow area. The actuator may be at least partially housed within the spinner and/or a hub of the compressor and/or a drive transmission shaft for the compressor. The actuator may be controlled by an engine electronic controller of the engine and control system, which may adjust the at least part of the spinner in response to sensed data (e.g. airflow velocity entering the intake and/or rotation rate of the compressor). Alternatively the actuator may be controlled by a dedicated spinner controller. The spinner controller may be at least partially housed within the spinner and/or the hub of the compressor and/or a drive transmission shaft for the compressor. Further the spinner controller may adjust the at least part of the spinner in response to one or more dedicated sensors that may be provided in or on the spinner. One such dedicated sensor may be an accelerometer provided inside the spinner. The actuator may be or any suitable design (e.g. mechanical, electric, hydraulic, pneumatic, magnetic or thermal).

In some embodiments the control system comprises one/or more resilient bodies biasing the at least part of the spinner towards one of reducing and increasing the smallest flow area. In this embodiment the actuator (where provided) may selectively overcome this bias in adjusting the at least part of the spinner in the opposite sense to the one or more biasing bodies. Alternatively adjustment of the at least part of the spinner in the opposite sense to the one or more biasing bodies may be achieved passively as a consequence of increased airflow velocity entering the intake and impinging on the at least part of the spinner. The resilient body or bodies may be elastic and could for example comprise deformable elastic walls of the spinner or one or more springs acting between the at least part of the spinner and a support structure.

In some embodiments an outer wall of the intake is shaped so as the flow area varies in an axial direction and the control system adjusts the at least part of the spinner by re-locating it with respect to the outer wall. It may be for instance that the at least part of the spinner is axially translated by the control system and that by moving the at least part of the spinner into or out of alignment with a portion of the intake having a smaller flow area, the size of the smallest flow area in the intake is adjusted.

Additionally or alternatively the control system adjusts the at least part of the spinner by altering its shape and/or extent. This may arise through deformation and/or reorientation/translation of an external wall of the spinner. It may be for instance that the control system selectively deforms the spinner external wall by porting pressurised gas or liquid into a cavity inside the spinner and behind the external wall. In this case the gas or liquid may inflate the at least part of the spinner until it is allowed to flow away by the control system. An alternative example is deforming the external wall through the action of the actuator providing a force thereon. The external wall may for instance simply deflect under the force exerted by the actuator. Alternatively the external wall may be provided with panels that are rotatably joined, (e.g. by means of a hinge) thereby allowing deformation of the external wall through rotation of one or more of the panels with respect to one another. A further example would be to form the external wall from shape memory alloy. In this case the control system may actively heat the external wall in order to return it to a default shape following deformation by the actuator. Alternatively the temperature of the shape memory alloy may be allowed to vary naturally in accordance with normal operation of the engine. A suitably selected shape memory alloy may allow the external wall to return to a default shape following actuator deformation at desired times in an operation cycle of the engine.

Where the control system supplies fluid (e.g. to drive the actuator or to inflate the spinner) it may be delivered via one or more passages through a drive arm connecting the compressor and the drive transmission shaft. Alternatively fluid may be supplied from inside the drive transmission shaft. The fluid may be compressed air bled from a core flow of the gas turbine engine, or alternatively a liquid such as oil, fuel, water or glycol. Where the control system sends a signal (e.g. that adjusts the actuator) this may be done wirelessly using a suitable transmitter and receiver, or may be achieved via a wired link passing through the drive transmission shaft. Where however a dedicated spinner controller is provided, signal transmission may be simplified as there may be no need to cross a static rotating boundary.

In some embodiments the control system is arranged to allow continuous adjustment of the at least part of the spinner. In this way the smallest flow area provided within the intake may be selected to be at various sizes between a maximum and minimum selectable using adjustment of the at least part of the spinner. It may be for instance that various intermediate axial positions of the at least part of the spinner are selectable between axial extreme positions that are also selectable. A further example would be selection of various degrees of partial inflation of the at least part of the spinner between maximum and minimum inflations which are also selectable. Alternatively it may be that the control system is arranged to allow only binary adjustment of the at least part of the spinner corresponding to minimum and maximum smallest flow area.

In some embodiments at least part of the spinner external wall has a conic or domed shape. Such a portion may exaggerate alteration in the smallest flow area, particularly where the adjustment is caused by re-location of the at least part of the spinner with respect to the outer wall of the intake duct shaped to vary the flow area in the axial direction.

In some embodiments the gas turbine engine may be a turbofan engine and the compressor may be a fan of turbofan engine. Further a gearbox may be provided in a drive path between the drive transmission shaft and the fan.

The gas turbine engine may be an aero gas turbine engine. Alternatively the gas turbine engine may be an industrial power generation engine.

According to a second aspect of the invention there is provided a method of operating the gas turbine engine of the first aspect comprising tending to adjust the at least part of the spinner to reduce the size of the smallest flow area provided within the intake when the compressor is rotating at slower speeds and increasing the size of the smallest flow area when the compressor is rotating at higher speeds. Additionally or alternatively the method may comprise operating the gas turbine engine of the first aspect to tend to adjust the at least part of the spinner to increase the size of the smallest flow area provided within the intake with increasing likelihood of choking of a root of the compressor given the conditions under which it is operating. It may be for instance that where the air compressed by the compressor is of higher density or is travelling at higher velocity, the likelihood of compressor root choking increases and can be compensated for by increasing the size of the smallest flow area and therefor flow diffusion. As will be appreciated control logic may be used to produce a compromise size of the smallest flow area where control based on compressor speed (or otherwise designed to improve compressor stability/surge margin) is in conflict with control based on reducing/preventing compressor root choking.

The skilled person will appreciate that except where mutually exclusive, a feature described in relation to any one of the above aspects may be applied mutatis mutandis to any other aspect. Furthermore except where mutually exclusive any feature described herein may be applied to any aspect and/or combined with any other feature described herein.

Embodiments will now be described by way of example only, with reference to the Figures, in which:

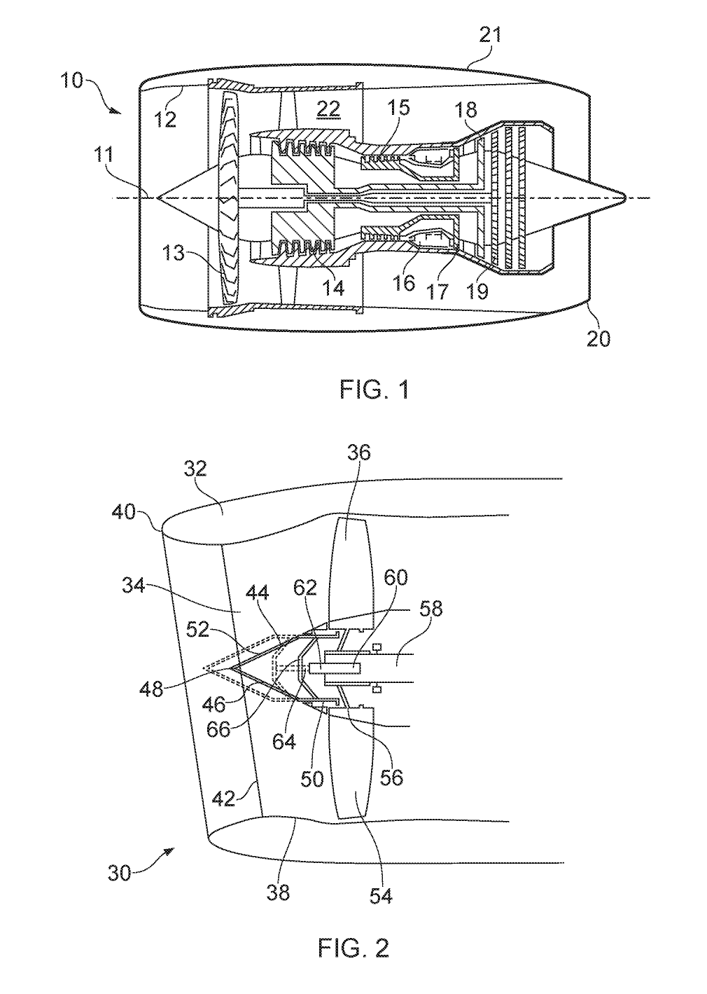

FIG. 1 is a sectional side view of a gas turbine engine;

FIG. 2 is a cross-sectional view of part of a gas turbine engine in accordance with an embodiment of the invention;

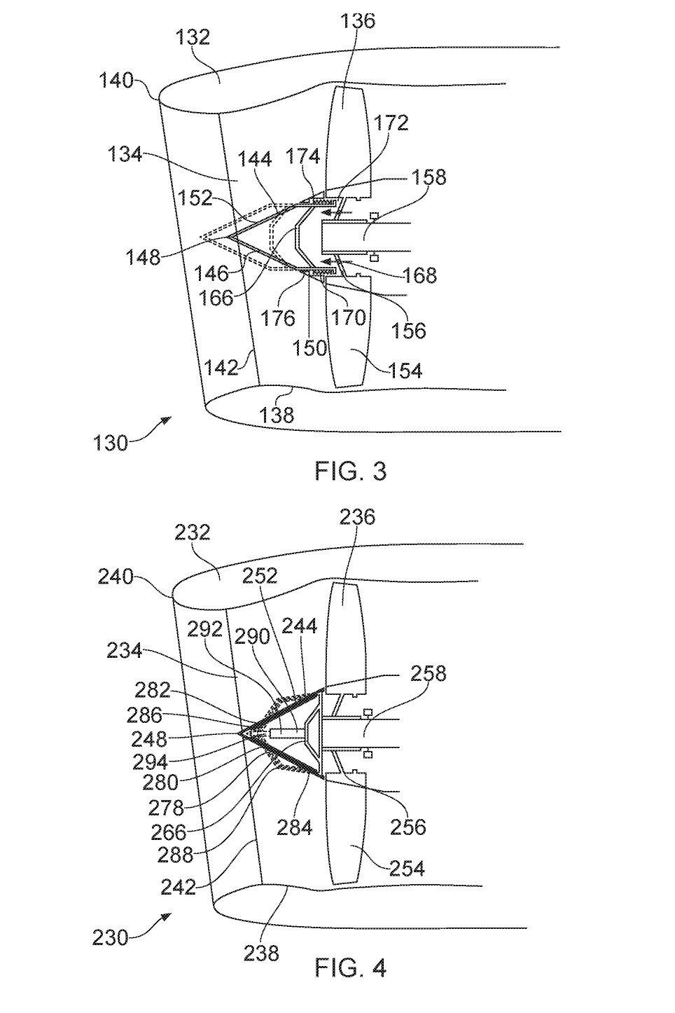

FIG. 3 is a cross-sectional view of part of a gas turbine engine in accordance with an embodiment of the invention;

FIG. 4 is a cross-sectional view of part of a gas turbine engine in accordance with an embodiment of the invention;

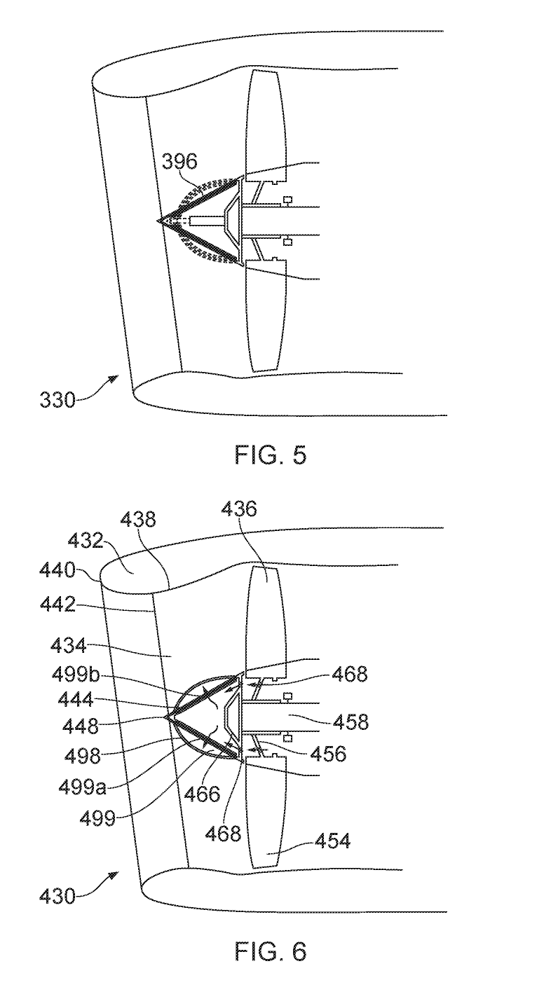

FIG. 5 is a cross-sectional view of part of a gas turbine engine in accordance with an embodiment of the invention;

FIG. 6 is a cross-sectional view of part of a gas turbine engine in accordance with an embodiment of the invention;

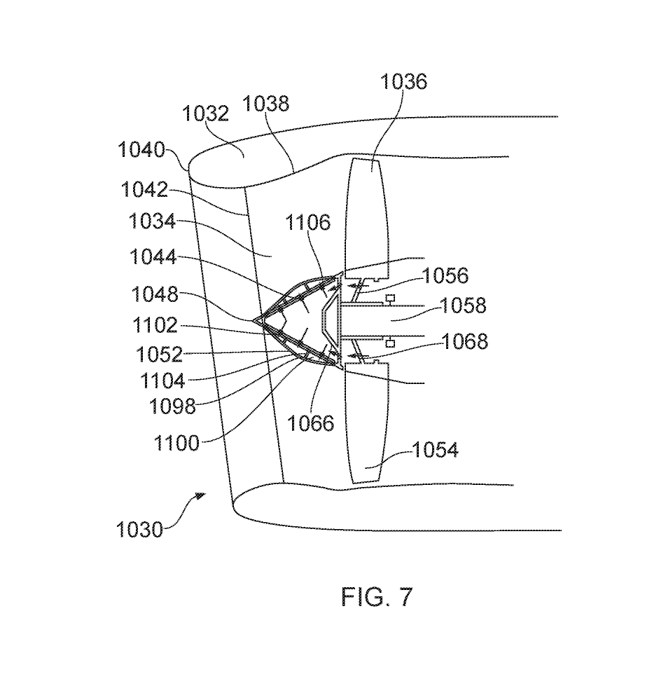

FIG. 7 is a cross-sectional view of part of a gas turbine engine in accordance with an embodiment of the invention.

With reference to FIG. 1, a gas turbine engine is generally indicated at 10, having a principal and rotational axis 11. The engine 10 comprises, in axial flow series, an air intake 12, a propulsive fan 13, an intermediate pressure compressor 14, a high-pressure compressor 15, combustion equipment 16, a high-pressure turbine 17, an intermediate pressure turbine 18, a low-pressure turbine 19 and an exhaust nozzle 20. A nacelle 21 generally surrounds the engine 10 and defines both the intake 12 and the exhaust nozzle 20.

The gas turbine engine 10 works in the conventional manner so that air entering the intake 12 is accelerated by the fan 13 to produce two air flows: a first air flow into the intermediate pressure compressor 14 and a second air flow which passes through a bypass duct 22 to provide propulsive thrust. The intermediate pressure compressor 14 compresses the air flow directed into it before delivering that air to the high pressure compressor 15 where further compression takes place.

The compressed air exhausted from the high-pressure compressor 15 is directed into the combustion equipment 16 where it is mixed with fuel and the mixture combusted. The resultant hot combustion products then expand through, and thereby drive the high, intermediate and low-pressure turbines 17, 18, 19 before being exhausted through the nozzle 20 to provide additional propulsive thrust. The high 17, intermediate 18 and low 19 pressure turbines drive respectively the high pressure compressor 15, intermediate pressure compressor 14 and fan 13, each by suitable interconnecting shaft.

Other gas turbine engines to which the present disclosure may be applied may have alternative configurations. By way of example such engines may have an alternative number of interconnecting shafts (e.g. two) and/or an alternative number of compressors and/or turbines. Further the engine may comprise a gearbox provided in the drive train from a turbine to a compressor and/or fan.

Referring now to FIG. 2 a forward portion of a turbofan engine is generally shown at 30. A nacelle 32 of the gas turbine engine defines an intake 34 leading to a compressor (in this case a fan 36). The intake 34 has an outer wall 38. The outer wall 38 is shaped so as the flow area therein varies in an axial direction. The nacelle 32 forms an intake lip 40 at its leading edge, from which the outer wall 38 converges in a downstream direction from the intake lip 40 towards a throat 42. The throat 42 defines the smallest flow area provided within the intake 34. From the throat 42 the outer wall 38 diverges in a downstream direction towards the fan 36.

The fan 36 has a spinner 44 positioned at its centre and projecting upstream into the intake 34. The spinner 44 has a conic fore portion 46 oriented so as the apex 48 of the cone is furthest upstream and a cylindrical aft portion 50. In the region of the spinner 44 the intake 34 has an annular shape defined between an external wall 52 of the spinner 44 and the outer wall 38.

Blades 54 of the fan 36 are coupled via a drive arm 56 to a drive transmission shaft 58. The drive transmission shaft 58 connects the fan 36 to a low pressure turbine (not shown). Secured to the drive transmission shaft 58 is a cylinder 60 of an actuator 62. The actuator 62 forms part of a control system that adjust the axial position of spinner 44, thereby relocating it with respect to the outer wall 38. A piston 64 of the actuator 62 is connected to the spinner 44 at a bracing plate 66 spanning the interior of the cylindrical aft portion 50. The fan 36 (including its spinner 44), drive transmission shaft 58 and actuator are connected so as to be fixed relative to each other. The spinner 44 rotates with the rest of the fan 36 when it rotates.

The actuator 62 is hydraulically operated and is controlled by an engine electronic controller (not shown). The engine electronic controller selectively actuates the piston 64 to alter its position within the cylinder 60, thereby axially translating the spinner 44 within the intake 34. The engine electronic controller controllers the actuator via means of a wireless link provided by a suitable transmitter and receiver. At a maximum extension of the piston 64 from the cylinder 60 the spinner 44 is located at its furthest possible upstream extent (i.e. furthest from the rest of the fan 36). This position of the spinner 44 is shown in shadow in FIG. 2 and corresponds to an adjustment to the smallest flow area provided within the intake such that it is at a minimum. This reduction in the smallest flow area is caused by a larger diameter part of the conic fore portion 46 being aligned with the throat 42. At a minimum extension of the piston 64 from the cylinder 60 the spinner 44 is located at its furthest possible downstream extent (i.e. nearest to the rest of the fan 36). This position of the spinner 44 is shown in FIG. 2 and corresponds to an adjustment to the smallest flow area provided within the intake such that it is at a maximum. This increase in the smallest flow area is caused by a smaller diameter part of the conic fore portion 46 being aligned with the throat 42.

In use the control system adjusts the spinner 44 in accordance with data indicative of the actual or predicted surge margin for the fan 36. In this case specifically, the engine electronic controller monitors one or more sensed or otherwise determined parameters that are indicative of the airflow velocity entering the intake 34. It then sets a desired spinner 44 axial position between its furthest possible upstream and downstream extents using signal data to which the actuator 60 responds accordingly. The controller adjusts the axial position of the spinner 44 using continuously variable control (although in other embodiments simple on/off style control (i.e. full forward, full back) may be used). In other embodiments one or more additional parameters impacting on surge margin may be sensed/determined and accounted for by the engine electronic controller e.g. load placed on a spool of the gas turbine engine by a generator. In further alternative embodiments the engine electronic controller may be a multi-variable controller that accounts for the impact of changes in the spinner axial position other than on surge margin. In this case the desired spinner 44 axial position set may be a compromise in view of additional operational constraints and/or desires e.g. extent/risk of fan root choking.

In general the engine electronic controller of the present embodiment sets the desired spinner 44 axial position such that as the axial velocity of the main airflow entering the intake 34 and reaching the fan 36 decreases, so the spinner 44 is moved further upstream and vice versa. This correspondingly and respectively decreases or increases the smallest flow area provided in the intake and so respectively increases or decreases the axial velocity of the main airflow reaching the fan 36. In this way the controller can adjust the working line of the compressor to increase its surge and/or flutter margins. The exact algorithm or scheduling used by the engine electronic controller will vary from embodiment to embodiment. Nonetheless by way of example it may be that the scheduled relationship between a sensed parameter and the outputted spinner 44 axial position could be a straight line with equation y=mx+c or may be a curve having the form of a quadratic, cubic, or higher order polynomial equation. Alternatively the relationship may be more complex, especially where additional operational constraints/desires are addressed.

Although in the present embodiment the engine electronic controller is responsible for controller the spinner 44 axial position, in alternative embodiments a separate and/or dedicated spinner controller may be provided for spinner control. Such a spinner controller may be at least partially housed within the spinner and/or a hub of the compressor and/or the drive transmission shaft for the compressor. Further the spinner controller may adjust the at least part of the spinner in response to one or more dedicated sensors that may be provided in or on the spinner. One such dedicated sensor may be an accelerometer provided inside the spinner.

Referring now to FIG. 3 a forward portion of a turbofan engine 130 that is similar to the arrangement of FIG. 2 is shown. The difference concerns the control system and specifically the replacement of the actuator 62. Similar features are provided with similar reference numerals in the series 100.

A nacelle 132 of the gas turbine engine defines an intake 134 leading to a compressor (in this case a fan 136). The intake 134 has an outer wall 138. The outer wall 138 is shaped so as the flow area therein varies in an axial direction. The nacelle 132 forms an intake lip 140 at its leading edge, from which the outer wall 138 converges in a downstream direction from the intake lip 140 towards a throat 142. The throat 142 defines the smallest flow area provided within the intake 34. From the throat 142 the outer wall 138 diverges in a downstream direction towards the fan 136.

The fan 136 has a spinner 144 positioned at its centre and projecting upstream into the intake 134. The spinner 144 has a conic fore portion 146 oriented so as the apex 148 of the cone is furthest upstream and a cylindrical aft portion 150. In the region of the spinner 144 the intake 134 has an annular shape defined between an external wall 152 of the spinner 144 and the outer wall 138.

Blades 154 of the fan 136 are coupled via a drive arm 156 to a drive transmission shaft 158. The drive transmission shaft 158 connects the fan 136 to a low pressure turbine (not shown). A bracing plate 166 spanning the interior of the cylindrical aft portion 150 is also provided.

The drive arm 156 comprises a plurality of passages 168 provided there through allowing fluid communication between an interior cavity of the cylindrical aft portion 150 and air delivery passage (not shown) for delivering compressed air from a compressor bleed (not shown) to the spinner 144. The air delivery passage is valve controlled such that the quantity of compressed air delivered to the interior cavity of the cylindrical aft portion 150 is controllable. Additionally an air dump passage (not shown) is provided in fluid communication with the air delivery passage. The air dump passage allows selective, valve controlled dumping of pressurised fluid from the interior cavity of the cylindrical aft portion 150 back through the passages 168 and out to atmosphere.

A resilient body, in this case a spring 170, acts between a circumferential lip 172 extending radially outwards from the cylindrical aft portion 150 and an internal circumferential rebate 174 of a shroud 176 that is connected to the fan 136. The shroud 176 provides a substantially continuous surface with the conic fore portion 146 that shrouds the cylindrical aft portion 150. The spring 170 urges the spinner 144 towards being located at its furthest possible downstream extent (i.e. nearest to the rest of the fan 136). This position of the spinner 144 is shown in FIG. 3 and corresponds to an adjustment to the smallest flow area provided within the intake 134 such that it is at a maximum. This increase in the smallest flow area is caused by a smaller diameter part of the conic fore portion 146 being aligned with the throat 142.

In contrast air supplied to the interior cavity of the cylindrical aft portion 150 urges the spinner 144 towards being located at its furthest possible upstream extent (i.e. furthest from the rest of the fan 136). This is achieved as a consequence of the force the compressed air exerts on the bracing plate 166, which overcomes the bias provided by the spring 170. The furthest possible upstream extent of the spinner 144 location is shown in shadow in FIG. 3 and corresponds to an adjustment to the smallest flow area provided within the intake 134 such that it is at a minimum. This decrease in the smallest flow area is caused by a larger diameter part of the conic fore portion 146 being aligned with the throat 142.

The position of the spinner 144 is controlled using similar inputs and control logic as the FIG. 2 embodiment, but with the engine electronic controller of the control system selectively actuating the valves of the air delivery passage and air dump passage to vary the quantity of pressurised fluid inside the cylindrical aft portion 150 and so the spinner 144 axial position.

Referring now to FIG. 4 a forward portion of a turbofan engine 230 that is similar to the arrangement of FIG. 2 is shown. The difference concerns the control system and specifically the positioning and effect of the actuator. Similar features are provided with similar reference numerals in the series 200.

A nacelle 232 of the gas turbine engine defines an intake 234 leading to a compressor (in this case a fan 236). The intake 234 has an outer wall 238. The outer wall 238 is shaped so as the flow area therein varies in an axial direction. The nacelle 232 forms an intake lip 240 at its leading edge, from which the outer wall 238 converges in a downstream direction from the intake lip 240 towards a throat 242. The throat 242 defines the smallest flow area provided within the intake 34. From the throat 242 the outer wall 238 diverges in a downstream direction towards the fan 236.

The fan 236 has a spinner 244 positioned at its centre and projecting upstream into the intake 234. The spinner 244 has a configuration in which it is conical in shape and is oriented so as the apex 248 of the cone is furthest upstream. In the region of the spinner 244 the intake 234 has an annular shape defined between an external wall 252 of the spinner 244 and the outer wall 238.

Blades 254 of the fan 236 are coupled via a drive arm 256 to a drive transmission shaft 258. The drive transmission shaft 258 connects the fan 236 to a low pressure turbine (not shown). A bracing plate 266 spans the interior of the spinner 244 and is connected to the transmission shaft 258.

The external wall 252 if the spinner 244 is provided by inner 278 and outer 280 walls. Each of the inner 278 and outer 280 walls has a plurality of fore 282 and a plurality of aft 284 plate segments. Each fore plate segment 282 is hingedly connected at its upstream end to a nose portion 286 of the spinner 244 and at its downstream end to an upstream end of one of the aft 284 plate segments, the latter occurring at a joint 288. Each aft plate segment 284 is hingedly connected at its downstream end to a peripheral region of the bracing plate 266. The inner 278 and outer 280 walls are offset with respect to each other such the fore 282 and aft 284 plates of the inner wall 278 are circumferentially misaligned with similar fore 282 and aft 284 plates of the outer wall 280. Specifically it may be that discontinuities between fore plates 282 of the outer wall 280 overlay the circumferential centres of fore plates 282 of the inner wall 278.

Secured to the bracing plate 266 is a cylinder 290 of an actuator 292. The actuator 292 forms part of a control system that adjusts the shape of the spinner 244, thereby altering the location and size of the smallest flow area in the intake 234. A piston 294 of the actuator 292 is connected to the nose portion 286 of the spinner 244. When the piston 294 is at its furthest limit of travel out of the cylinder 290 it locates the nose portion 286 at the limit of its travel in an upstream direction. In this position of the nose portion 286 shown in FIG. 4, each fore panel 282 forms a substantially continuous flat surface with the aft panel 284 to which it is hingedly connected, thus giving the spinner 244 a conic shape. With the spinner 244 in this configuration the smallest flow area provided within the intake 234 is at a maximum.

In contrast when the piston 282 is fully retracted with respect to the cylinder 278, it locates the nose portion 286 at the limit of its travel in a downstream direction.

This adjustment in the nose portion 286 position is accommodated in part by rotation of hingedly joined fore 282 and aft 284 panels with respect to one another about their respective joints 288. In particular the joints 288 move outwards thereby decreasing the rake of the fore 282 panels (shown in shadow).

In view of this adjustment discontinuities between each adjacent fore panel 282 and each adjacent aft panel 284 increase in size. Nonetheless in view of the offset of the inner 278 and outer 280 walls, the panels 282, 284 of the inner wall 278 substantially block the discontinuities, larger though they are, between the panels 282, 284 of the outer wall 280. Thus the spinner 244 continues to present a substantially continuous outer surface. With the spinner 244 in this configuration the smallest flow area provided within the intake 234 is at a minimum, as provided between the joints 288 and the outer wall 238.

The position of the nose portion 286 and therefore the shape of the spinner 244 is controlled using similar inputs and control logic as the FIG. 2 embodiment. Specifically the same inputs and control logic are used, but the actuator 280 is used to adjust the shape of the spinner 244.

Referring now to FIG. 5 a forward portion of a turbofan engine 330 that is similar to the arrangement of FIG. 4 is shown. In the FIG. 5 embodiment however, the segmented inner and outer walls of the spinner are replaced by a continuous surface 396 that is flexed in a predictable manner (between conic and domed shapes) by operation of the piston on the nose portion. With the spinner in the conic configuration, the smallest flow area provided within the intake is at a minimum, whereas with the spinner in the domed configuration, the smallest flow area provided within the intake is at a maximum. In an alternative interpretation of FIG. 5 the outer wall of the spinner comprises shape memory alloy material supported in part by the piston of an unpowered actuator. In such an embodiment the outer wall may be selectively heated or cooled in order to change the shape of the shape memory alloy and so alter the smallest flow area provided within the intake. By way of example selective heating may be achieved by delivering hot compressed air to an interior cavity of the spinner (see for example the manner in which compressed air is delivered as described with respect to the FIG. 6 arrangement below).

Referring now to FIG. 6 a forward portion of a turbofan engine 430 is shown which combines a similar spinner structure to that of the FIG. 5 arrangement with pneumatic control similar to the FIG. 3 arrangement. Similar features are provided with similar reference numerals in the series 400.

A nacelle 432 of the gas turbine engine defines an intake 434 leading to a compressor (in this case a fan 436). The intake 434 has an outer wall 438. The outer wall 438 is shaped so as the flow area therein varies in an axial direction. The nacelle 432 forms an intake lip 440 at its leading edge, from which the outer wall 438 converges in a downstream direction from the intake lip 440 towards a throat 442. The throat 442 defines the smallest flow area provided within the intake 1034. From the throat 442 the outer wall 438 diverges in a downstream direction towards the fan 436.

The fan 436 has a spinner 444 positioned at its centre and projecting upstream into the intake 434. The spinner 444 has a configuration in which it is conical in shape and is oriented so as the apex 448 of the cone is furthest upstream. In the region of the spinner 444 the intake 434 has an annular shape defined between an external wall 452 of the spinner 444 and the outer wall 438.

Blades 454 of the fan 436 are coupled via a drive arm 456 to a drive transmission shaft 458. The drive transmission shaft 458 connects the fan 436 to a low pressure turbine (not shown). A bracing plate 466 spanning the interior of the cylindrical aft portion 450 is also provided.

The drive arm 456 and bracing plate 466 comprise a plurality of passages 468 provided there through allowing fluid communication between an interior cavity of the spinner 444 and an air delivery passage (not shown) for delivering compressed air from a compressor bleed (not shown) to the spinner 444. The air delivery passage is valve controlled such that the quantity of compressed air delivered to the interior cavity of the spinner 444 is controllable. Additionally an air dump passage (not shown) is provided in fluid communication with the air delivery passage. The air dump passage allows selective, valve controlled dumping of pressurised fluid from the interior cavity of the spinner 444 back through the passages 468 and out to atmosphere.

A resilient body, in this case an elastic external wall 498 of the spinner 444 biases the spinner 444 towards having a conical shape. This configuration of the spinner 444 gives rise to the smallest flow area provided within the intake 434 being at its maximum.

In contrast compressed air supplied to the interior cavity of the spinner 444 tends to inflate the spinner 444 by overcoming the bias created by the elastic external wall 498. The elastic external wall 498 is inflated through the ingress of compressed air into a chamber 499 located immediately adjacent the elastic external wall 498. The chamber 499 is formed by the elastic external wall 498 on one side and a support wall 499a on the other. Chamber passages 499b are provided through the support wall 499a to allow fluid communication between the chamber 499 and the interior cavity of the spinner 444. When fully inflated the spinner 444 has a domed shape that is commensurate with the smallest flow area provided within the intake 434 being at a minimum.

The shape of the spinner 444 is controlled using similar inputs and control logic as the FIG. 2 embodiment, but with the engine electronic controller of the control system selectively actuating the valves of the air delivery passage and air dump passage to vary the quantity of pressurised fluid inside the spinner 444 and so the extent of its inflation.

Referring now to FIG. 7 a forward portion of a turbofan engine 1030 is shown which similar to the arrangement of FIG. 6, but modified to allow more convoluted inflated spinner shapes. Similar features are provided with similar reference numerals in the series 1000.

A nacelle 1032 of the gas turbine engine defines an intake 1034 leading to a compressor (in this case a fan 1036). The intake 1034 has an outer wall 1038. The outer wall 1038 is shaped so as the flow area therein varies in an axial direction. The nacelle 1032 forms an intake lip 1040 at its leading edge, from which the outer wall 1038 converges in a downstream direction from the intake lip 1040 towards a throat 1042. The throat 1042 defines the smallest flow area provided within the intake 1034. From the throat 1042 the outer wall 1038 diverges in a downstream direction towards the fan 1036.

The fan 1036 has a spinner 1044 positioned at its centre and projecting upstream into the intake 1034. The spinner 1044 has a configuration in which it is conical in shape and is oriented so as the apex 1048 of the cone is furthest upstream. In the region of the spinner 1044 the intake 1034 has an annular shape defined between an external wall 1052 of the spinner 1044 and the outer wall 1038.

Blades 1054 of the fan 1036 are coupled via a drive arm 1056 to a drive transmission shaft 1058. The drive transmission shaft 1058 connects the fan 1036 to a low pressure turbine (not shown). A bracing plate 1066 spanning the interior of the cylindrical aft portion 1050 is also provided.

The drive arm 1056 and bracing plate 1066 comprise a plurality of passages 1068 provided there through allowing fluid communication between an interior cavity of the spinner 1044 and an air delivery passage (not shown) for delivering compressed air from a compressor bleed (not shown) to the spinner 1044. The air delivery passage is valve controlled such that the quantity of compressed air delivered to the interior cavity of the spinner 1044 is controllable. Additionally an air dump passage (not shown) is provided in fluid communication with the air delivery passage. The air dump passage allows selective, valve controlled dumping of pressurised fluid from the interior cavity of the spinner 1044 back through the passages 1068 and out to atmosphere.

A resilient body, in this case an elastic external wall 1098 of the spinner 1044 biases the spinner 1044 towards having a conical shape. This position of the spinner 1044 gives rise to the smallest flow area provided within the intake 1034 being at its maximum.

In contrast compressed air supplied to the interior cavity of the spinner 1044 tends to inflate the spinner 1044 by overcoming the bias created by the elastic external wall 1098. The elastic external wall 1098 is inflated through the ingress of compressed air into discrete chambers 1100 located immediately adjacent the elastic external wall 1098. The chambers 1100 are formed by the elastic external wall 1098 on one side, a manifold wall 1102 on the other and side walls 1104 which separate adjacent chambers 1100. Chamber passages 1106 are provided through the manifold wall 1102 to allow fluid communication between each chamber 1100 and the interior cavity of the spinner 1044. When fully inflated the spinner 1044 has a distorted dome shape, the distortion arising in view of the length of each side wall 1104 having been selected so as to restrain the inflation of the elastic external wall 1098 in a manner so as to give that overall shape. When the spinner 1044 is fully inflated the smallest flow area provided within the intake 1034 is at a minimum.

The shape of the spinner 1044 is controlled using similar inputs and control logic as the FIG. 2 embodiment, but with the engine electronic controller of the control system selectively actuating the valves of the air delivery passage and air dump passage to vary the quantity of pressurised fluid inside the spinner 1044 and so the extent of its inflation.

It will be understood that the invention is not limited to the embodiments above-described and various modifications and improvements can be made without departing from the appended claims. Except where mutually exclusive, any of the features may be employed separately or in combination with any other features and the disclosure extends to and includes all combinations and sub-combinations of one or more features described herein.

1. A gas turbine engine comprising a compressor and an intake leading to the compressor, the compressor having a spinner, at least part of the spinner being adjustable to alter the size of the smallest flow area provided between the spinner and the intake, wherein an outer wall of the intake is shaped so as the flow area varies in an axial direction and the spinner is adjustable to both alter its shape and re-locate it axially with respect to the outer wall.

2. A gas turbine engine according to claim 1 comprising a control system arranged to adjust the at least part of the spinner to alter the smallest flow area provided within the intake.

3. A gas turbine engine according to claim 2 where the control system comprises an actuator that selectively adjusts the at least part of the spinner to decrease and/or increase the smallest flow area.

4. A gas turbine engine according to claim 3 where the actuator is controlled by a dedicated spinner controller.

5. A gas turbine engine according to claim 4 where the spinner controller is at least partially housed within the spinner and/or the hub of the compressor and/or a drive transmission shaft for the compressor.

6. A gas turbine engine according to claim 2 where the control system comprises one/or more resilient bodies biasing the at least part of the spinner towards one of reducing and increasing the smallest flow area.

7. A gas turbine engine according to claim 1 where the control system supplies fluid for adjusting the spinner shape to alter the size of the smallest flow area provided within the intake.

8. A gas turbine engine according to claim 7 where the fluid is delivered via one or more passages through a drive arm connecting the compressor and the drive transmission shaft.

9. A gas turbine engine according to claim 2 where the control system is arranged to allow continuous adjustment of the at least part of the spinner.

10. A gas turbine engine according to claim 1 where at least part of the spinner external wall has a conic or domed shape.

11. A gas turbine engine according to claim 1 where the gas turbine engine is a turbofan engine and the compressor is a fan.

12. A gas turbine engine according to claim 1 where the gas turbine engine is an aero gas turbine engine.

13. A method of operating the gas turbine engine of claim 1 comprising adjusting the at least part of the spinner to reduce the size of the smallest flow area provided within the intake when the compressor is rotating at slower speeds and increasing the size of the smallest flow area when the compressor is rotating at higher speeds.

14. A gas turbine engine comprising a compressor and an intake leading to the compressor, the compressor having a spinner, at least part of the spinner being adjustable to alter the size of the smallest flow area provided between the spinner and the intake, wherein an outer wall of the intake is shaped to provide a flow area that varies in an axial direction; wherein the spinner has a plurality of fore plate segments and aft plate segments, each fore plate segment hingedly connected at its upstream end to a nose portion and at its downstream end to an upstream end of an aft plate segment.
